(19) United States
(12) Patent Application Publication
(10) Pub. No.: US 2026/0187568 A1
(43) Pub. Date: Jul. 2, 2026

(54) METHOD AND SYSTEM FOR VISUALLY DISPLAYING PERFORMANCE AND COMPETITION DATA BASED ON K-LINE AND BOLLINGER BANDS THEREOF

(71) Applicant: GUANGZHOU MEDICAL UNIVERSITY, GUANGZHOU CITY (CN)

(72) Inventor: HONGBO FU, GUANGZHOU CITY (CN)

(21) Appl. No.: 19/097,984

(22) Filed: Apr. 2, 2025

Related U.S. Application Data
(63) Continuation of application No. PCT/CN2024/144262, filed on Dec. 31, 2024.

(30) Foreign Application Priority Data
Dec. 27, 2024 (CN) 2024119466897

(51) Int. Cl. G06Q 10/0639

(52) U.S. Cl. CPC G06Q 10/0639

(57) ABSTRACT

The disclosure relates to a method and system for visually representing performance and competition data using K-line charts and Bollinger Bands. The method includes: collecting performance data related to a preset competition object; processing the performance data to construct K-line and Bollinger Band indicators; representing performance trends where hollow K-lines indicate progress and solid K-lines indicate retrogression; and visually displaying the marked K-lines and Bollinger Bands. This visual representation system provides intuitive performance analysis by combining multi-dimensional performance data with statistical indicators, enabling effective assessment of progress trends, performance stability, and statistical anomalies. The system particularly benefits performance analysis in education, sports, and competitive activities by transforming abstract numerical data into visually interpretable patterns and trends.

### CROSS-REFERENCE TO RELATED APPLICATIONS

This application is a continuation of PCT/CN2024/144262, filed on Dec. 31, 2024 and claims priority to Chinese Patent Application No. 202411946689.7, filed on Dec. 27, 2024 the contents of which are hereby incorporated by reference.

### TECHNICAL FIELD

The application relates to the technical field of data analysis, in particular to a method for visually displaying performance and competition data based on K-line and Bollinger Band.

### BACKGROUND

The conventional methods for displaying academic performance typically present examination results using simple data tables or basic graphics such as line charts, scatter plots, and box charts. These visualization approaches either lack intuitive clarity or display limited information dimensions. The financial market, being a mature sector that requires tools to display, analyze, and manage large volumes of data, has developed sophisticated graphical techniques that may be effectively adapted to visualize educational, sports, and competition results.

Within financial markets, particularly in stock trading analysis, Bollinger Bands and K-line charts are widely used visualization tools. The K-line shows short-term price fluctuations and key pricing points. The Bollinger Band shows the long-term trend of the market and provides rich and intuitive statistical information and forms, which is convenient for market participants to make statistical analysis and decisions quickly. When combined, these graphical technologies offer enhanced visualization capabilities beyond standard charts, displaying data characteristics across multiple dimensions-including median, maximum, and minimum values—and most importantly, rendering the critical statistical indicators of mean and standard deviation in a visually dynamic format.

Traditional methods of recording and presenting performance data suffer from several limitations, particularly in their lack of dynamic representation and interactivity, making it difficult to visually track progress and identify fluctuation patterns throughout the learning process. The specific disadvantages include:

The existing chart methods (such as line charts and scatter plots) may not simultaneously display the multi-dimensional aspects of a single assessment;
1. statistical indicators (such as mean and standard deviation) are typically presented in numerical format rather than graphical form, significantly reducing intuitive understanding;
2. current visualization methods lack automated mechanisms for detecting and alerting users to abnormal performance patterns;
3. conventional approaches struggle to effectively illustrate the relative relationship between individual achievement and group-level performance; and
4. the static nature of historical data presentation limits effective analysis of long-term performance trends and patterns.

### SUMMARY

This disclosure aims to address the limitations of traditional performance visualization methods by proposing a novel approach that leverages K-line and Bollinger Band techniques from financial analysis. By applying these sophisticated visualization methods to performance and competition data, this invention enables dynamic, multi-dimensional representation of statistical characteristics and historical trends, significantly enhancing the visualization capabilities for performance assessment.

In order to achieve the above objectives, the disclosure provides the following technical scheme:

A method for visually displaying performance and competition data based on K-line and Bollinger Bands, including:
collecting performance data related to a preset competition object;
processing the performance data to construct corresponding indicators of the K-line and Bollinger Band, where a hollow K-line represents performance progress, and a solid K-line represents performance decline; the moving average of the performance data constitutes the middle track of the Bollinger Band; and a weighted standard deviation is added to or subtracted from the moving average to form the upper and lower rails of the Bollinger Band;
detecting and marking K-line data points that exceed the upper or lower rails of the Bollinger Band;
automatically identifying performance anomalies in real-time by detecting data points that fall beyond predefined upper or lower Bollinger Band thresholds, and selectively filtering these outliers from the visualization to prevent misrepresentation while maintaining a record of these anomalies for analytical purposes;
displaying the marked K-line and Bollinger Band to realize the visual representation of achievements and characteristics, and evaluating progress;
the personal achievements include: date, initial personal achievement in the preset window, final personal achievement in the preset window, personal highest score in the preset window and personal lowest score in the preset window; and
the group achievements include: date, group performance in the preset window, highest group score in the preset window, and lowest group score in the preset window.

The method for visually displaying performance and competition data based on K-line and Bollinger Bands, applying to scoring performance analysis of players and players of the same type; the method includes:
collecting performance data related to players and players of the same type; where the performance data includes: game date, individual scores of players, scores of players of the same type, the highest score of the same type of player, and the lowest score of the same type of player;
processing the performance data to construct the corresponding indicators of K-line and Bollinger Band;
identifying and marking data points where the K-line exceeds the upper and lower rails of Bollinger Bands; and
displaying the marked K-line and Bollinger Band to realize the visual representation of achievements and their characteristics, and evaluate the progress.

Optionally, the performance data organized into K-line form includes:
using the average score of players of the same type as the beginning data of K-line, the individual score of players as the end data of K-line, the highest score of players of the same type as the highest data of K-line, and the lowest score of players of the same type as the lowest data of K-line;
constructing the K-line using the start data, end data, highest data, and lowest data;
where the hollow K-line indicates progress and the solid K-line indicates retrogression; and
the method of organizing the score data into Bollinger Band includes:
defining a preset number of games as a moving window, where the width of the moving window is larger than that of the K-line; calculating the average score of the players within the window to construct the middle track; adding the preset standard deviation to the average score to construct the upper track; and subtracting the preset standard deviation from the average score to construct the lower track.

The method for visually displaying performance and competition data based on K-line and Bollinger Bands, applying to Rubik's cube racing training analysis; the method includes:
collecting the performance data related to the players; where the performance data include: training date, each restoration time, and daily data records; where the daily data records include: first attempt time, last attempt time, fastest completion time, and slowest completion time;
processing the performance data to construct the corresponding indicators of K-line and Bollinger Band;
marking the data points where the K-line exceeds the upper and lower rails of the Bollinger Band; and
displaying the marked K-lines and Bollinger Bands to realize the visual representation of achievements and characteristics, and evaluate the progress.

Optionally, organizing the performance data into K-line form includes:
using the first restoration time as K-line start data, the last restoration time as K-line end data, the slowest restoration time as the highest data of K-line, and the fastest restoration time as the lowest data of K-line;
constructing the K-line using the start data, end data, highest data, and lowest data;
where the hollow K-line indicates progress and the solid K-line indicates retrogression; and
the method of organizing the score data into Bollinger Bands includes:
defining a preset number of training days as the window period; calculating the average restoration time within the preset date to construct the Bollinger middle track; adding the preset standard deviation to the average restoration time to construct the Bollinger upper track; and
subtracting the preset standard deviation from the average restoration time to construct the Bollinger lower track.

The method for visually displaying performance and competition data based on K-line and Bollinger Bands, applying to test score analysis; the method includes:
collecting relevant performance data of candidates; where the score data includes:
exam times and exam scores;
processing the performance data to construct the corresponding indicators of K-line and Bollinger Band;
marking the data points where the K-line exceeds the upper and lower rails of the Bollinger Band; and
displaying the marked K-lines and Bollinger Bands to realize the visual representation of achievements and characteristics, and evaluate the progress.

Optionally, organizing the performance data into K-line form includes:
presetting several sessions as a K-line window;
using the median score in the K-line window as the K-line start data, the current exam score as K-line end data, the average value plus preset standard deviation of the tests in the K-line window as the highest data of the K-line, and the average minus preset standard deviation of the tests in the K-line window as the lowest data of the K-line;
where the hollow K-line indicates progress and the solid K-line indicates retrogression;
organizing data into Bollinger Bands includes:
defining several sessions as the Bollinger Band window; and
calculating the average value of the exams in the Bollinger Band window to construct the middle track; adding the preset standard deviation to the middle track to construct the upper track; and subtracting the preset standard deviation from the middle track to construct the lower track.

A system for visually displaying performance and competition data based on K-line and Bollinger Bands, the system includes: a data acquisition module, a data processing module, a marking module, and a visualization module;
the data acquisition module is used for acquiring performance data related to the preset object competition;
the data processing module is used for processing the performance data to construct K-line and Bollinger Bands respectively; where the hollow K-line indicates progress and the solid K-line indicates retrogression;
the marking module is used for identifying and marking the data points where the K-line exceeds the upper and lower rails of the Bollinger Band; and
the visualization module is used for displaying the marked K-line and Bollinger Bands visually and evaluating the progress.

Optionally, collecting the performance data related to the preset object competition in the data collection module includes:
collecting both individual achievement data and group achievement data;
the personal achievements include: date, initial personal achievement within the preset window, the last personal achievement in the preset window, the highest personal achievement in the preset window, and the lowest personal achievement in the preset window; and
the group achievements include: date, group achievement within the preset window, the last group achievement in the preset window, the highest group achievement in the preset window, and the lowest group achievement in the preset window.

The disclosure provides the following beneficial effects:

The method enables dynamic visualization of performance data through a step-by-step process: first, collecting performance data related to a preset competition object; second, processing the data to construct K-line and Bollinger Band indicators; third, identifying and marking data points where the K-line exceeds the Bollinger Band thresholds; and finally, displaying the marked visualizations to evaluate progress. This approach enables real-time performance monitoring with interactive data visualization, including mouse-hovering feedback for detailed analysis. Anomalous data points (e.g., significantly above or below expected ranges) are automatically marked for quick identification, helping users pinpoint areas that require attention (S) or areas of excellent performance (G) in real-time. The visualization system enhances interactivity through real-time data viewing on mouse hover; provides automatic marking of exceptional (G) and concerning (S) performance points; distinguishes between progressive and regressive states through hollow and solid K-lines; reflects performance stability changes through Bollinger Band width variations; offers convenient data export to Excel for storage and further analysis; and supports the visualization of multiple groups of test data simultaneously.

### BRIEF DESCRIPTION OF THE DRAWINGS

In order to more clearly explain the technical schemes in the embodiments of the present disclosure, the drawings needed for the embodiments will be briefly introduced below. It should be noted that the drawings in the following description represent only some embodiments of the present disclosure, and other drawings may be derived from these without creative effort by persons skilled in the field.

FIG. 1 is a K-line and Bollinger Band chart showing the scoring performance analysis of a shooting guard compared to other shooting guards on the team, featuring interactive data display and performance indicators.

FIG. 2 is a K-line and Bollinger Band visualization of daily Rubik's cube solving training performance, showing time-based progression with detailed data popup for performance analysis.

FIG. 3 is a K-line and Bollinger Band representation of a student's academic performance over time, featuring score tracking, performance markers, and statistical analysis indicators.

FIG. 4 is a system architecture and data flow diagram of the performance and competition data visualization method based on K-line and Bollinger Band analysis, showing the complete workflow from data input to report generation.

### DETAILED DESCRIPTION OF THE EMBODIMENTS

The following description clearly and comprehensively explains the technical schemes of the disclosure with reference to the attached drawings. The described embodiments represent only a portion of possible implementations of the disclosure, not the entirety. All other embodiments derived by those skilled in the art without creative effort fall within the protection scope of this disclosure.

To make the objects, features, and advantages of this disclosure more evident and understandable, a detailed description is provided with reference to the attached drawings and specific embodiments.

### Embodiment 1

This embodiment provides a method for visually representing performance and competition data using K-line charts and Bollinger Bands, including:
collecting performance data related to a predefined competitive activity;
organizing the performance data into K-line and Bollinger Band indicators, where hollow K-lines represent performance improvement (progress), solid K-lines represent performance decline (regression), the moving average (MA) of performance data forms the middle line of the Bollinger Band, the weighted standard deviation (SD) is added to or subtracted from the moving average to create the upper and lower lines of the Bollinger Band;
marking K-line data that extends beyond the upper and lower lines of the Bollinger Bands (where “W” indicates performance requiring attention and “G” indicates exceptional performance); and
Displaying the marked K-lines and Bollinger Bands visually to illustrate performance characteristics and evaluate progress.

Further, collecting performance data related to the predefined competitive activity includes gathering both individual achievements and group or class achievements. Individual achievement data typically uses several sequential assessment points as a time window to form a K-line for observation. Alternatively, individual achievements may be observed within the context of group achievements, where personal scores, class scores, and corresponding statistical indicators collectively constitute a K-line for comprehensive analysis.

Individual achievement data includes: date, initial personal achievement within the preset window, final personal achievement within the preset window, highest personal achievement within the preset window, and lowest personal achievement within the preset window. Specifically, in this embodiment, a preset window including four assessment points is established to evaluate the fourth assessment, with the first three assessments combined to form a K-line for observation. The achievement data typically represents the best performance in the same category.

Group achievement data includes: date, group performance within the preset window, highest group score within the preset window, and lowest group score within the preset window.

Through the innovative application of K-line charts and Bollinger Bands, this embodiment enables dynamic visualization of performance data, making learning progress more intuitive. Specifically:
K-line charts integrate multi-dimensional data (first assessment, best performance, worst performance, and last assessment) of a single test into a unified visual representation;
Bollinger Bands intuitively illustrate learning trends and fluctuation ranges through moving average and standard deviation channels.

Specific technical advantages include:
1. real-time data viewing through mouse hover functionality, enhancing interactivity;
2. automatic identification and marking of excellent performance (G) and performance requiring attention (S), enabling timely problem identification;
3. visual distinction between progress and regression through hollow and solid K-lines;
4. visualization of performance stability through changes in Bollinger Band width;
5. excel table import and export functionality for convenient data storage and further analysis;
6. support for statistical analysis and display of multiple groups of assessment data.

### Embodiment 2

This embodiment provides a method for visually representing performance and competition data using K-line charts and Bollinger Bands, specifically applied to scoring performance analysis of athletes and athletes of the same type. The method includes:
collecting performance data related to a specific athlete and athletes of the same type, where the performance data includes: game date, individual scores of the athlete, average scores of athletes of the same type, highest score of athletes of the same type, and lowest score of athletes of the same type;
organizing the performance data to construct corresponding K-line and Bollinger Band indicators;
marking data points where the K-line extends beyond the upper and lower lines of the Bollinger Bands; and
displaying the marked K-lines and Bollinger Bands visually to illustrate performance characteristics and evaluate progress.

Further, organizing performance data into K-line format includes:
using the average score of athletes of the same type as the opening value of the K-line, the individual score of the athlete as the closing value of the K-line, the highest score of athletes of the same type as the highest value of the K-line, and the lowest score of athletes of the same type as the lowest value of the K-line;
constructing the K-line using these four data points (opening, closing, highest, and lowest values), with hollow K-lines indicating progress and solid K-lines indicating regression; and
organizing score data into Bollinger Bands by:
establishing a preset number of games (for example, four games) as a moving window, with the width of the moving window being wider than that of the K-line; using the average score of athletes within the moving window as the middle line, adding a preset standard deviation to this average to determine the upper line, and subtracting a preset standard deviation from this average to determine the lower line.

Specifically, this embodiment performs K-line and Bollinger Band analysis of an athlete's performance compared to athletes of the same type. This example evaluates the performance of a specific player within group Z, following these steps:

### 1. Data Acquisition Stage

The input data includes: competition date (typically every 2-3 days); player points per game (PPG); average scores of players of the same type, such as the team's other shooting guards (TeamGuardAvg); highest score of players of the same type (TeamGuardHigh); and lowest score of players of the same type (TeamGuardLow).

### 2. K-Line Construction

In this embodiment, K-line data is constructed for each game, where, opening value=average score of players of the same type; closing value=player's score; highest value=highest score of players of the same type; lowest value=lowest score of players of the same type;

### Example

Game data includes: average score of team guards: 15 points (opening value), player's score: 18 points (closing value), highest score among team guards: 22 points (highest value), lowest score among team guards: 8 points (lowest value).

### 3. Trend Analysis (Simulating Data Based on a Trend Analysis Model):

Benchmark curve design: Starting point for rookie season: 8 points; Growth goal: 18 points; Growth curve: exponential growth model; baseProgress=8+10*(1−exp(−linspace(0, 2, n)′))
Adding random fluctuations: regular fluctuation: reference value of 4 points; exceptional performance (15% probability): benchmark value+10 points; underperformance (10% probability): benchmark value is 8 points;

### 4. Bollinger Band Analysis

Window period: most recent 10 games; middle line: average score of 10 games; upper line: average score+2 standard deviations; kower line: average score−2 standard deviations

Example data: average of 10 games: 15 points; standard deviation: 3 points; upper line: 21 points; lower line: 9 points

### 5. Performance Evaluation

Exceptional performance (G): score>upper line; example: player scores 23 points>upper line at 21 points;
performance requiring attention (W): score<lower line; example: player scores 7 points<lower line at 9 points

### 6. Data Visualization

Graphic elements include: X-axis: competition date (MM/DD format, with year displayed only at the beginning of the year); Y-axis: score range (0-40 points); K-line: shows performance in a single game; Bollinger Bands: reflect recent trends;

### 7. Interactive Design

The interactive design features mouse hover information display showing:
competition date; personal score; average score of team guards; highest/lowest scores; 10-game Bollinger Band average data; performance evaluation;

### 8. Data Storage

Data is stored in Excel tables including: game date; personal score data;
team data; statistical indicators; file name: player_scoring_data.xlsx

Through the combination of K-line charts and Bollinger Bands, this embodiment intuitively shows: 1. Comparison between a player and other shooting guards on the team; 2. Stability of individual scores; 3. Performance trends and growth curves; 4. Automatic identification of exceptional and underperformance.

This embodiment is suitable for: tracking rookie player development; scout data analysis; coaching staff's technical and tactical adjustments; player self-evaluation.

This analysis method maintains the rigor of traditional technical statistics while enhancing data readability and intuition, providing a novel analytical tool for player development evaluation.

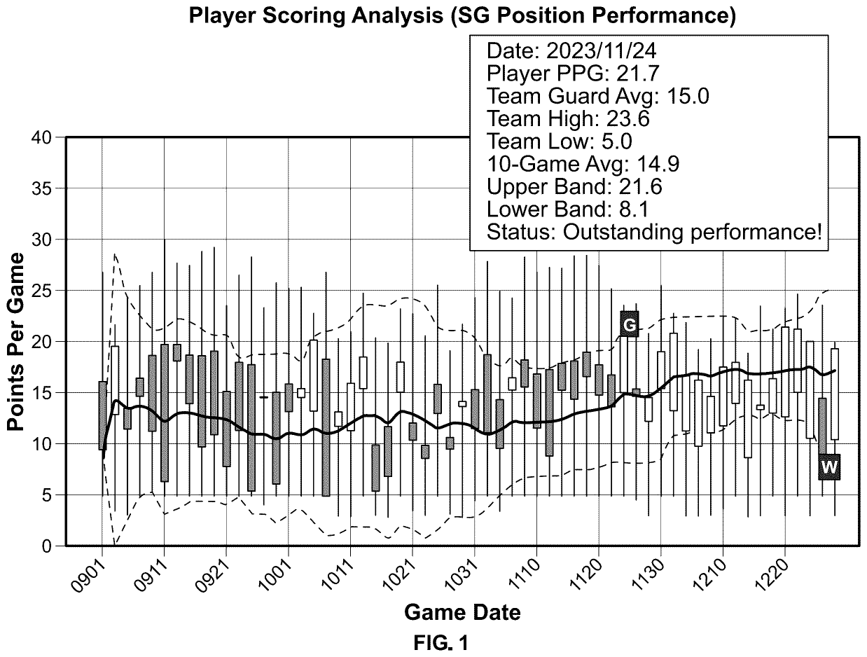

FIG. 1 shows a K-line and Bollinger Band chart comparing one shooting guard's scores versus other shooting guards on a team (with mouse hover popup window). Clicking a K-line marked with “G” displays the corresponding game data information.

### Embodiment 3

This embodiment provides a method for visually representing performance and competition data using K-line charts and Bollinger Bands, specifically applied to Rubik's cube solving training analysis. The method includes:
collecting performance data related to participants, where the performance data includes: training date, individual solve times, and daily data records. Daily data records include:
first attempt time, last attempt time, fastest completion time, and slowest completion time;
organizing the performance data to construct corresponding K-line and Bollinger Band indicators;
marking data points where the K-line extends beyond the upper and lower lines of the Bollinger Bands; and
displaying the marked K-lines and Bollinger Bands visually to illustrate performance characteristics and evaluate progress.

Further, organizing performance data into K-line format includes:
using the first solve time as the opening value of the K-line, the last solve time as the closing value of the K-line, the slowest solve time as the highest value of the K-line, and the fastest solve time as the lowest value of the K-line;
organizing score data into Bollinger Bands by:
establishing a preset number of training days as the window period, using the average solve time within this preset period to construct the Bollinger Band middle line. Adding a preset standard deviation to this average to determine the upper line, subtracting a preset standard deviation from this average to determine the lower line

Specifically, this embodiment applies to Rubik's cube solving training analysis, expressing K-lines and Bollinger Bands for multiple data points within a time window (one training day):

### 1. Data Acquisition Stage

Data acquisition includes: Training date (daily training); individual solve times (multiple attempts); daily data records: first attempt time, last attempt time, fastest completion time, slowest completion time.

### 2. K-Line Construction

In this embodiment, K-line data is constructed for daily training, where, opening value=first solve time; closing value=last solve time; highest value=slowest solve time; lowest value=fastest solve time;
Example: training data for a single day (4 attempts); first time: 32.5 seconds (opening value); last time: 30.1 seconds (closing value); slowest time: 35.2 seconds (highest value); fastest time: 29.8 seconds (lowest value).

### 3. Progress Curve Analysis (Simulating Data Based on a Trend Analysis Model);

Reference curve design: initial level: 35 seconds; target level: 25 seconds; progress curve: exponential decline model; base_times=35exp(−0.02(1:n)′)); adding random fluctuations: daily training attempts: 3-6 times; fluctuation amplitude: gradually decreases with increased training; coefficient of variation: 0.2exp(−0.02i), where i represents the number of windows.

### 4. Bollinger Band Analysis

Setting analysis of Bollinger Bands: window period: most recent 10 training days; middle line: average time of 10 days; upper line: average time+2 standard deviations; lower line: average time−2 standard deviations
Example: 10-day average: 28.5 seconds; standard deviation: 2 seconds; upper line: 32.5 seconds; lower line: 24.5 seconds.

### 5. Performance Evaluation

Exceptional performance (G): solve time<lower line; example: completion time of 23.5 seconds<lower line at 24.5 seconds; performance requiring attention (S): solve time>upper line; example: completion time of 33 seconds>upper line at 32.5 seconds.

### 6. Data Visualization:

Graphic elements include: X-axis: training date (MM/DD format, with year displayed only at the beginning of the year); Y-axis: time range (10-55 seconds); K-line color: hollow (white fill) indicates progress (last time<first time); solid (blue fill) indicates regression (last time>first time).

### 7. Interactive Functionality:

Interactive features include hover information display showing: training date; number of training attempts; detailed timing information; first/last solve times; average time; Bollinger Band data; performance evaluation.

### 8. Data Storage:

Data is stored in Excel tables including: first solve time; slowest/fastest times; final solve time; moving average; upper and lower limits of Bollinger Bands.

This embodiment is suitable for: 1. introductory Rubik's cube solving training; 2. daily practice for competitive solvers; 3. coach tracking of student progress; 4. competition preparation analysis.

The innovative aspects of this embodiment include: 1. K-line representation reflecting the quality of one day's training; 2. enhanced stability measurement through Bollinger Bands; 3. unified display of multiple training data points; 4. intuitive distinction between progress and regression; 5. automatic identification of anomalous performance. This analysis method combines: comprehensive traditional training records; visual advantages of financial technical analysis; statistical rigor; interactive interface convenience. It provides a professional data analysis tool for Rubik's cube training, helping practitioners better understand training effectiveness and progress trends.

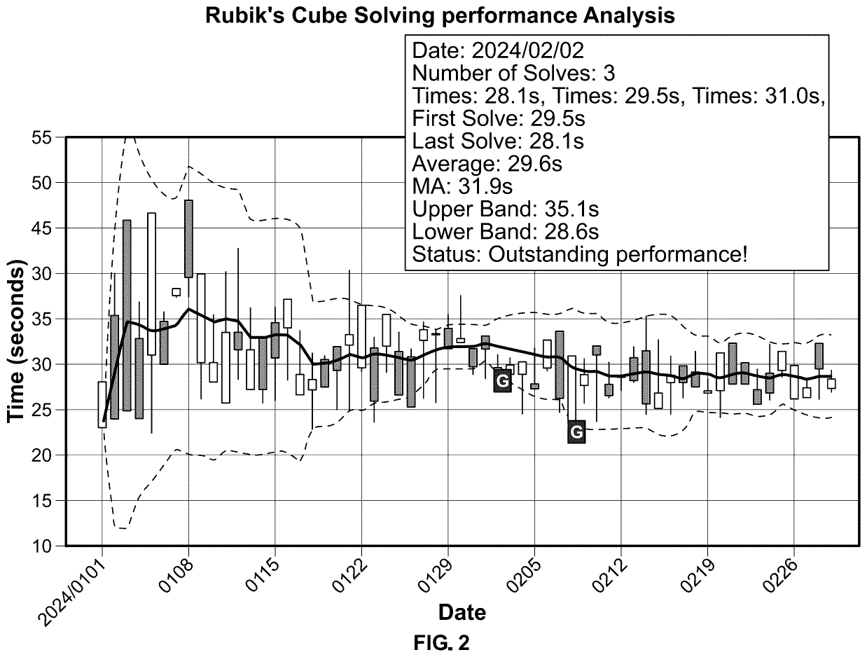

FIG. 2 shows examples of K-line and Bollinger Band representations of a participant's daily Rubik's cube training performance data (with mouse hover popup window showing specific data and information corresponding to a single K-line).

### Embodiment 4

This embodiment provides a method for visually representing performance and competition data using K-line charts and Bollinger Bands, specifically applied to test score analysis. The method includes:
collecting relevant performance data of test-takers, where the data includes: exam instances and exam scores;
organizing the performance data to construct corresponding K-line and Bollinger Band indicators;
marking data points where the K-line extends beyond the upper and lower lines of the Bollinger Bands; and
displaying the marked K-lines and Bollinger Bands visually to illustrate performance characteristics and evaluate progress.

Further, organizing performance data into K-line format includes:
establishing several consecutive exam instances as the K-line window;
using the median score within the K-line window as the opening value of the K-line, the current exam score as the closing value of the K-line, the mean score plus a preset standard deviation within the K-line window as the highest value of the K-line, and the mean score minus a preset standard deviation within the K-line window as the lowest value of the K-line;
using hollow K-lines to indicate progress and solid K-lines to indicate regression;
organizing score data into Bollinger Bands by:
establishing several exam instances as the Bollinger Band window; and
using the mean score within the Bollinger Band window to construct the middle line, adding a preset standard deviation to this mean to determine the upper line, and subtracting a preset standard deviation from this mean to determine the lower line.

Specifically, this embodiment focuses on test score evaluation. For situations requiring one data point per time window, this embodiment redefines the data characteristics corresponding to K-line data ports by leveraging the temporal complementarity of K-lines and Bollinger Bands.

Data characteristics in this embodiment include: Sample size: 60 exams; score range: 50-100 points; observation window (K-line window): 5 exams; Bollinger Band window: 10 exams

Example: Benchmark value for an exam: 75 points; Normal range: 69-81 points; Extended range: 55-90 points.

### K-Line Calculation Methodology:

In this embodiment, the K-line corresponds to a window of 5 consecutive exams, where, opening value=median score within the time window; highest value=mean+1.5 standard deviations; lowest value=mean−1.5 standard deviations; closing value=score of the current exam; average value=mean score of the next exam.

Numerical range controls: highest value upper limit: 100 points; lowest value lower limit: 50 points.

### Bollinger Band Analysis:

Calculation parameters include: middle line: 10-exam moving average; upper line: middle line+2 standard deviations; lower line: middle line−2 standard deviations.

Initial value processing: if exam count<3: standard deviation=standard deviation of all current exams; Otherwise: standard deviation=standard deviation of the most recent exam

### Performance Evaluation Mechanism:

Exceptional performance (G): when score>upper line, indicating significantly exceeding the stable level;
Performance requiring attention (W): when score<lower line, indicating need for focused attention

### Visual Design:

Visual design includes graphic configuration, drawing elements, and Bollinger Band color schemes:

Graphic configuration: window size 1200×600; coordinate range: X-axis (test number−2 to n+2), Y-axis (score 45-115); drawing elements: K-line chart in blue; Bollinger Bands: middle line as red solid line, upper and lower lines as red dotted lines.

### Interactive Functionality

Interactive features include mouse hover information display showing: exam date; actual score; median score; moving average; upper and lower limits of Bollinger Bands; and performance evaluation

Information box settings: position: dynamically adjusted; size: 0.3×0.25; background: white; and border: black.

### Data Storage

### Data is Stored in Excel Files:

Example Table 1 (daily_data): test number, actual score, median score, highest score, lowest score, moving average, upper and lower Bollinger Band limits
Example Table 2 (statistics): average score, standard deviation, median, highest score, lowest score, instances of exceeding upper line, instances of falling below lower line, system characteristics

The effects of this embodiment include:
Evaluation dimensions: single test performance; stability over time periods; long-term progress trends; and anomalous performance identification.
Application value: learning effectiveness evaluation; early warning of performance fluctuations; learning plan adjustment; and test performance analysis.
Innovations: multi-dimensional performance display; dynamic evaluation criteria; Instant interactive feedback; and automatic anomaly identification.
Usage scenarios: daily examination evaluation; learning progress tracking; teaching quality monitoring; and student growth portfolios.

This embodiment provides an intuitive and scientifically robust analysis tool for educational evaluation, helping teachers and students better understand and improve the learning process.

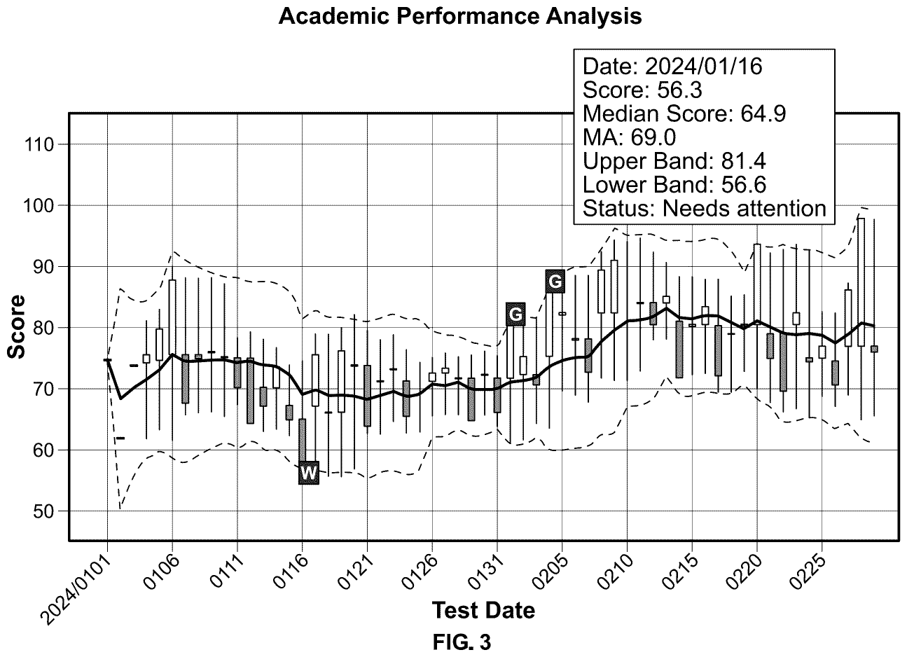

FIG. 3 shows an example of K-line and Bollinger Band representation of a student's academic performance (with mouse hover popup window showing specific data and information corresponding to a single K-line).

### Embodiment 5

This embodiment provides a system for representing performance and competition data based on K-line charts and Bollinger Bands, including: a data acquisition module, a data processing module, a marking module, and a visualization module.

The data acquisition module collects performance data related to the predefined competitive activity;
the data processing module organizes the performance data into K-line and Bollinger Band indicators, where hollow K-lines indicate progress and solid K-lines indicate regression;
the marking module marks data points where the K-line extends beyond the upper and lower lines of the Bollinger Bands; and
the visualization module displays the marked K-lines and Bollinger Bands visually and evaluates progress.

Further, the data acquisition module collects:
performance data related to the predefined competitive activity, including individual achievement and group or class achievement;
individual achievement data, including: date, initial personal achievement within the preset window, final personal achievement within the preset window, highest personal achievement within the preset window, and lowest personal achievement within the preset window; and
group or class achievement data, including: date, group achievement within the preset window, final group achievement within the preset window, highest group achievement within the preset window, and lowest group achievement within the preset window.

Specifically, the data acquisition module collects original performance data from external sources (such as user input, file import, etc.).

The input to the data acquisition module consists of performance data from individual assessments. Users may manually enter performance data or import it from external files (such as Excel or CSV). Data is sorted and stored chronologically for subsequent processing.

The output of the data acquisition module is the chronologically sorted time series of original data.

The data processing module calculates the indicators for K-line (Candlestick) charts and Bollinger Bands.

The input to the data processing module is standardized time series data (performance data).

The output of the data processing module is K-line data and Bollinger Band data (including moving average, upper and lower lines).

K-line calculation: calculates the opening, closing, highest, and lowest values based on the sequence of results, determines the progress/regression state, and decides whether to use solid or hollow K-lines. Bollinger Band calculation: establishes the moving window size, calculates the moving average (MA), standard deviation (SD), and the upper and lower lines of the Bollinger Band, and marks whether scores exceed the Bollinger Band (indicating either performance requiring attention or exceptional performance).

The visualization module generates a graphical interface and handles user interactions;
the input to the visualization module is the calculated K-line and Bollinger Band data;
the output of the visualization module is a dynamically generated graphical interface displaying the K-line chart and Bollinger Bands;
K-line drawing: draws solid and hollow K-lines based on the calculation results, indicating progress or regression. Bollinger Band drawing: draws the moving average, upper and lower lines, and marks anomalous data points. Interactive functionality: monitors mouse hover events, displays relevant information boxes (showing dates, scores, statistical indicators, etc.), and supports dynamic adjustment of information box positioning.

The data storage module saves and exports analysis results;
the input to the data storage module is data processing and visualization results;
the output of the data storage module is exported analysis result files (such as Excel files);
the results of each analysis are saved, with support for multi-table design (such as daily summary tables and detailed data tables). Results may be exported to Excel format for subsequent viewing or archiving.

The core algorithm flow and control logic of this embodiment are as follows:

### 1. Data Initialization Stage:

Input: all score data from individual assessments
Processing: organizes and stores data chronologically, ensuring the data format and order meet the requirements for subsequent analysis
Output: normalized time series data (sorted by date, including each score)

### 2. K-Line Calculation Stage:

Input: all score data from individual assessments
Processing: calculates opening, closing, highest, and lowest values
Output: calculated K-line data

### 3. Bollinger Band Calculation Stage:

Input: closing value data
Processing: establishes moving window size (n) and calculates moving average (MA) and standard deviation (SD) for each window
Calculates Bollinger Band upper and lower lines according to MA and SD:

$$Upper line = MA + 2 * SD$$

$$Lower line = MA - 2 * SD$$

Output: Bollinger Band upper and lower line data

### 4. Anomalous Performance Marking:

Input: closing values, Bollinger Band upper and lower lines
Processing: if closing value>upper line, marks as “G” (exceptional performance);
if closing value<lower line, marks as “W” (performance requiring attention)
Output: anomalous performance markers (G, W)

### 5. Interactive Functionality Implementation:

Input: data points in the graphical interface
Processing: monitors mouse movement events, obtains mouse coordinates, and determines proximity to data points
Dynamically displays information boxes showing relevant data (such as date, performance, statistical indicators, etc.)
Adjusts information box positioning to ensure visibility
Output: dynamically updated interface displaying detailed performance information and statistical indicators

The key design and technical components used in this embodiment are as follows:

### 1. Data Structure Design:

### Copy Code

daily_data={date: test date, scores: [score1, score2, . . . ], % all results from a single day open: first achievement, % opening value close: last achievement, % closing value high: highest score, % highest value low: lowest score, % lowest value ma: moving average, % moving average upper: Bollinger Band upper line, % Bollinger Band upper line lower: Bollinger Band lower line % Bollinger Band lower line}

### 2. Visualization Implementation:

### Coordinate System:

X-axis: indicates test date
Y-axis: indicates score range (typically 0 to 100)

### K-Line Drawing:

Solid K-line: indicates regression
Hollow K-line: indicates progress

### Bollinger Band Drawing:

Moving average: solid line
Bollinger Band upper and lower lines: dotted lines

### 3. Interactive Implementation:

### Event Monitoring:

Mouse movement event: monitors mouse coordinates to determine proximity to data points

### Dynamic Updates:

Information box content: displays relevant dates, scores, and statistical information
Dynamic adjustment of information box positioning: ensures the information box doesn't obscure other content in the view

### 4. Data Export:

### Excel File Export:

Supports export of summary tables and detailed data tables, including dates, scores, and statistical indicators

### System Usage Process (Module-Based):

### Data Input:

Manual entry or file import

### Parameter Setting:

Establishes Bollinger Band period (10 days by default) and display range (specific date interval)

### Visual Analysis:

Users examine score trends, identify anomalous performance, and evaluate progress

### Data Export:

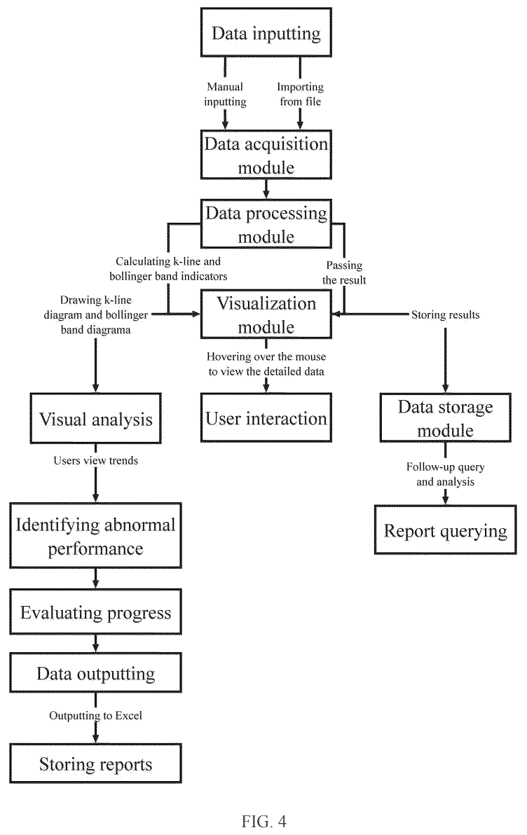

exports analysis results to Excel format and saves the report;
control logic and inter-module connections:
the data acquisition module inputs original score data to the data processing module for analysis;
the data processing module calculates K-line and Bollinger Band indicators based on time series data and transmits calculation results to the visualization module for graphical display;
the visualization module renders the processed data as K-line charts and Bollinger Bands, supporting mouse hover functionality to view detailed data;
the data storage module saves processing and visualization results to files for subsequent query and analysis;
FIG. 4 shows the system architecture and data flow.

The advantage of this embodiment is that through the innovative application of K-line charts and Bollinger Bands, it enables dynamic visualization of performance data, making the learning progress process more intuitive. Specifically:

K-line charts integrate multi-dimensional data (first assessment, best performance, worst performance, and last assessment) from a single test into a unified visual representation.

Bollinger Bands intuitively illustrate learning trends and fluctuation ranges through moving average and standard deviation channels.

### Specific Technical Advantages:

1. Real-time data viewing through mouse hover functionality, enhancing interactivity.
2. Automatic identification and marking of exceptional performance (G) and performance requiring attention (W), enabling timely problem identification.
3. Visual distinction between progress and regression through hollow and solid K-lines.
4. Visualization of performance stability through changes in Bollinger Band width.
5. Excel table export functionality for convenient data storage and further analysis.
6. Support for statistical analysis and display of multiple groups of assessment data.

The above embodiments describe only the preferred implementations of this disclosure and do not limit its scope. Any modifications and improvements made by those skilled in the art to the technical schemes of this disclosure, without departing from its design principles, fall within the protection scope defined by the claims.

What is claimed is:

1. A method for visually displaying performance and competition data based on K-line and Bollinger Band by a computing system, comprising:
(a) collecting performance data related to a preset competition object;
(b) constructing corresponding indicators of K-line and Bollinger Band based on the performance data, wherein a hollow K-line represents progress, and a solid K-line represents retrogression; the moving average of the performance data constitutes the middle track of the Bollinger Band; and a weighted standard deviation is added to or subtracted from the moving average to form the upper and lower rails of the Bollinger Band;
(c) detecting and marking K-line data points that exceed the upper or lower rails of the Bollinger Band;
(d) adjusting threshold values for marking K-line data based on real-time performance fluctuations;
(e) optimizing performance trend analysis by refining the weightings of the Bollinger Band based on historical data patterns;
(f) identifying and filtering performance anomalies in real-time;
(g) excluding filtered anomalies from visual display to maintain statistical integrity; and
(h) displaying the marked K-lines and Bollinger Bands to visually represent performance achievements and trends.

2. The method according to claim 1, wherein collecting the performance data related to the preset competition object comprises gathering both individual performance and group performance data, wherein the individual performance data comprises: date, initial personal achievement in the preset window, final personal achievement in the preset window, highest personal score in the preset window, and lowest personal score in the preset window; and
the group performance data comprises: date, average group performance in the preset window, highest group score in the preset window, and lowest group score in the preset window.
